(19) United States
(12) Patent Application Publication
(10) Pub. No.: US 2025/0011593 A1
(43) Pub. Date: Jan. 9, 2025

(54) THERMOPLASTIC COMPOSITION OF POLY(2,6-DIALKYL-1,4-PHENYLENE)ETHERS AND STYRENE POLYMERS WITH CORE-SHELL PARTICLES

(71) Applicant: Kulzer GmbH, Hanau (DE)

(72) Inventors: Hannah HUESMANN, Weinheim (DE); Alfred HOHMANN, Schmitten (DE); Andreas GRUNDLER, Muenzenberg (DE)

(73) Assignee: Kulzer GmbH, Hanau (DE)

(21) Appl. No.: 18/709,289

(22) PCT Filed: Nov. 8, 2022
(86) PCT No.: PCT/EP2022/081075

§ 371 Date: May 10, 2024

(30) Foreign Application Priority Data
Nov. 12, 2021 (DE) 10 2021 129 543.2

(51) Int. Cl. C08L 71/02; C08J 3/20; C08K 3/40; C08K 9/06; C08L 25/06

(52) U.S. Cl. CPC C08L 71/02; C08J 3/203; C08K 3/40; C08K 9/06; C08L 25/06; C08J 2325/06; C08J 2371/02; C08J 2433/12; C08K 2201/005; C08L 2207/53

(57) ABSTRACT

The object of the invention is a thermoplastic composition comprising
A) 5 to 5000 parts by weight of poly(dialkylphenylene) ether with alkyl comprising 1 to 6 carbon atoms,
B) 100 parts by weight of thermoplastic styrene polymer,
C) 0.001 to 1500 parts by weight of core-shell particles, wherein the shell of the core-shell particles comprises thermoplastic polymers, in particular thermoplastic acrylate-based polymers comprising homo- and copolymers, and the core comprises elastomers, in particular elastic polymers comprising homo- and copolymers or mixtures of polymers, whose TG is below 0° C., and
D) 0 to 2550 parts by weight of inorganic filler.

### CROSS-REFERENCE TO RELATED APPLICATIONS

This application is a 371 of International Patent Application No. PCT/EP2022/081075, filed Nov. 8, 2022, which claims priority of German Patent Application No. 10 2021 129 543.2, filed Nov. 12, 2021, the entire contents of which patent applications are hereby incorporated herein by reference.

### FIELD OF THE DISCLOSURE

The object of the invention is a thermoplastic composition comprising
A) 5 to 5000 parts by weight of poly(dialkylphenylene) ether, in particular poly(2,6-dialkyl-1,4-phenylene) ether, poly(2,6-dialkyl-1,3-phenylene) ether, in each case independently with alkyl having 1 to 6 carbon atoms, and mixtures thereof,
B) 100 parts by weight of thermoplastic styrene polymer, in particular comprising homopolymers and copolymers of styrene and optionally other monomers,
C) 0.001 to 1500 parts by weight of core-shell particles, wherein the shell of the core-shell particles comprises thermoplastics, in particular thermoplastic polymers, preferably thermoplastic acrylate-based polymers comprising homo- and copolymers, and the core comprises elastomers, in particular elastic polymers comprising homo- and copolymers or mixtures of polymers, whose TG is below 0° C., and
D) 0 to 2550 parts by weight of inorganic filler as well as thermoplastic moldings made from this composition as well as the use of the composition for the production of, among other things, medical human prostheses or prostheses in the veterinary field.

### BACKGROUND

In the dental sector, a wide variety of products are manufactured from the high-performance polymer PAEK materials, such as polyetherketone (PEK), polyetheretherketone (PEEK) and polyetherketoneketone (PEKK), arylketone polymer (AKP). The high performance plastic has good biocompatibility, low specific gravity and machinability in cutting, especially milling processes. Disadvantage of the high-performance polymer PEEK is its high initial cost. In addition, it has been reported that the mechanical properties of PEEK are degraded with inorganic fillers in the nanometer range. PEEK is also widely used in electronics as well as medical technology, aerospace and automotive applications. PEEK has a melting point of 343° C. and is a high-temperature-resistant, thermoplastic, semi-crystalline plastic. The glass transition temperature is 143° C.

Polyetherketones (PEEK) have been successfully used in the following indication groups for about two decades: Fixed prostheses that are conditionally removable, screw-retained on implants, bridges, splinted crowns in the posterior region, bridges spanning the jaw, telescoping on implants, and also for non-removable prostheses, such as cemented dentures, or for removable dentures, such as bars. However, only unfilled PEEK has been used in dental applications to date because unfilled PEEK has sufficient flexibility to protect implants from long-term loading. Bar-supported prostheses can be removed by the patient without abrasion due to the mechanical properties of PEEK on PEEK. However, PEEK filled with inorganic fillers loses its flexibility, which is used to protect the implants. The mechanical properties of PEEK are very well suited for dental applications, with values of 204 to 215 MPa for flexural strength and values of 4,950 to 5,000 MPa for E-modulus, and even higher values depending on the modification. For PEEK moldings pressed from granules, lower values are achieved with a flexural strength of around 180 MPa and E-modulus around 3,900 MPa. PEEK materials have a low abrasion and discoloration tendency and exhibit elasticity comparable to bone. Only the bonding to other materials, the esthetics and the very high melting points of the thermoplastic high-performance polymers require extensive and cost intensive processing.

### SUMMARY OF THE DISCLOSURE

There is therefore a need for high-performance polymers that can be processed at lower temperatures and preferably allow lighter and/or more stable bonding to other materials. The object of the invention was to provide a material, in particular a material suitable in the medical field, preferably a prosthesis material, which exceeds the specifications of the DIN ISO 20795-1-2013 standard in terms of total work and flexural strength and fracture toughness. Furthermore, the object was that the material should be producible without the addition of monomers or the use of volatile solvents. In addition, a material should be provided whose mechanical properties meet the requirements of DIN ISO 20795-1 even with a content of inorganic fillers. Furthermore, it should be possible to process the material by generative methods, extruders or injection molding. A further object was to provide a material with high fracture toughness, in particular a prosthetic material, which permits higher feed rates during milling and thus shorter process times during milling.

It was surprisingly found that a material, especially a prosthetic material/-based material, with the required properties in terms of overall work function, flexural strength and fracture toughness, and preferably in terms of transparency specifications, can be provided by adding core-shell particles to a thermoplastic blend of poly(dialkylphenyl) ethers, in particular predominantly poly-(2,6-dialkyl-1,4-phenylene) ethers, and thermoplastic styrene polymer.

The use of poly(dialkylphenyl) ethers, in particular poly-(2,6-dialkyl-1,4-phenylene) ethers and mixtures of isomers, and thermoplastic styrene polymer as a polymer blend (mPPE, modified polyethers) for the production of dental prosthetic parts has the advantage that the thermoplastics exhibit very good dimensional stability, low dimensional shrinkage and low water absorption as well as a low tendency to hydrolysis, and at the same time have a low density with significantly lower melting temperatures compared to PEEK. If the modified polyethers are filled with a certain content of inorganic fillers or pigments without the presence of core-shell particles, the value for flexural strength (MPa/m²) decreases. By adding core-shell particles, the total work of fracture as a measure of long-term behavior can be significantly improved compared to microcracking. The total work function can be more than doubled depending on the content of core-shell particles. With additional addition of inorganic fillers, a higher E-modulus can be achieved.

Surprisingly, it was found that by adding core-shell particles to the modified polyethers, the mechanical properties in terms of work at fracture and/or total work at fracture can be further improved with respect to unmodified polyethers on the one hand, and the tolerance of the material in terms of mechanical properties can be significantly increased compared to the addition of inorganic fillers.

The production of dental materials places the highest demands on the mechanical properties due to the daily, high forces within the framework of masticatory loading and the simultaneously high esthetic demands on dental materials. Therefore, suitable additives must be stable over the long term, must not negatively change the mechanical properties in an aqueous environment and, at the same time, must meet the mechanical criteria of DIN ISO 20795-1.

According to the invention, the problem is solved by using core-shell particles in a thermoplastic composition, in particular a medical and/or dental, preferably a medical and/or dental prosthetic composition or medical and/or dental prosthetic composition, of from
A) 5 to 5000, preferably from 50 to 2500, in particular from 50 to 950, parts by weight of poly(dialkylphenylene) ether, in particular comprising poly(2,6-dialkyl-1,4-phenylene) ether and optionally poly(2,6-dialkyl-1,3-phenylene) ether, and mixtures thereof, in each case independently with alkyl comprising 1 to 6 carbon atoms, preferably with alkyl comprising 1 to 3 carbon atoms,
B) 100 parts by weight of thermoplastic styrene polymer, in particular comprising homo- and copolymers of styrene, and
C) from 0.001 to 1500, in particular from 10 to 1275, preferably from 20 to 300, parts by weight of core-shell particles, the shell of the core-shell particles comprising thermoplastics, in particular thermoplastic acrylate-based polymers comprising homo- and copolymers, and the core comprising elastomers, in particular elastic polymers comprising homo- and copolymers or mixtures of polymers whose TG is below 0° C.

### BRIEF DESCRIPTION OF THE DRAWINGS

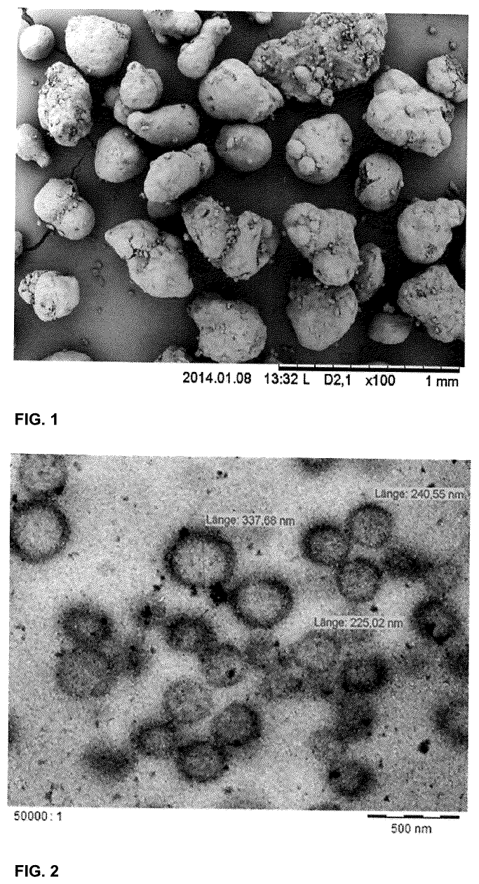

The invention will now be described in greater detail, wherein FIGS. 1 (SEM) and 2 (TEM) show images of the respective images of the agglomerated particles.

### DETAILED DISCLOSURE

The poly(dialylphenylene) ethers and the polystyrene form a so-called polymeric alloy.

Particularly preferred core-shell particles according to the invention can be present in aggregated form. The tasks can be solved by using aggregated core-shell particles (irregularly shaped aggregates, d₅₀˜50-300 μm, in particular 200 to 300 μm), the primary particles preferably having a size in the range 100-400 nm. The particle size can be determined by optical methods (Hitachi MT 1000, sample is sputtered with gold and measured optically). The core-shell particles are presumably present in aggregate in the solid due to surface interactions. Alternatively preferred are aggregates of core-shell particles with a mean particle size of the core-shell particles of d₅₀=50 to 300 micrometers, preferably from 100 to 200 micrometers. Due to the high shear forces during production in the extruder, the aggregates are broken down into the primary particles. In equally preferred applications, it may be preferable to provide core-shell particles having a refractive index synonymous with refractive index similar to the polymer blend or polymer alloy comprising poly-(2,6-dialkyl-1,4-phenylene) ether and styrene polymer. Therefore, the core-shell particles preferably have a refractive index of 1.45 to 1.55. Preferably, a refractive index of about 1.49 is at (R.I.˜1.4900). Alternatively, the particle size can be determined as volume size using a Mastersizer 2000, Hydro 2000, dispersion: cyclohexane).

According to the invention, core-shell particles, which may be present as an aggregate, are particularly suitable for use, but these aggregates can be separated into the individual particles by mixing with particulate thermoplastic polymers or melting the thermoplastic polymers, in particular the aggregates of the core-shell particles in the mixture or melt can be separated into the individual core-shell particles. Thus, the core-shell particles in the thermoplastic composition and/or in a product made from the thermoplastic composition are preferably present separated from each other and homogeneously distributed in the matrix of the composition.

By using core-shell particles according to the invention as high-impact additive in the thermoplastic compositions comprising poly(dialkylphenylene) ether with alkyl having 1 to 6 C atoms, in particular poly(2,6-dialkyl-1,4-phenylene) ether and optionally poly(2,6-dialkyl-1,3-phenylene) ether or mixtures of these, in each case independently with alkyl having 1 to 6 C atoms, preferably having 1 to 3 C atoms, and thermo plastic styrene polymer can be used to produce materials, in particular prosthesis materials, which meet the requirements of ISO 20795-1 with regard to high-impact properties. In addition, a thermoplastic composition can be provided for use as a prosthetic material.

The thermoplastic compositions according to the invention are preferably free of residual monomers and suitable as a medical material for the production of medical moldings, such as medical prostheses, dental prostheses, dental products, products that come into contact with body fluids, such as parts of medical devices, instruments or apparatus. Likewise, the thermoplastic composition can be used in technology for the production of technical components, such as in aircraft construction, vehicle construction, functional samples, furniture or even in the food and cosmetics sector.

The object of the invention is a thermoplastic composition comprising from
A) 5 to 5000 parts by weight, in particular from 50 to 2500, preferably from 50 to 950 parts by weight, of poly(dialkylphenylene) ethers with alkyl having 1 to 6 carbon atoms, in particular poly(2,6-dialkyl-1,4-phenylene) ethers and optionally poly(2,6-dialkyl-1,3-phenylene) ethers or mixtures thereof, in each case independently with alkyl having 1 to 6 carbon atoms,
B) 100 parts by weight of thermoplastic styrene polymer, in particular a homo- or co-polymer of a styrene polymer,
C) 0.001 to 1500, in particular 10 to 850, parts by weight of core-shell particles, wherein the shell of the core-shell particles comprises thermoplastics, in particular thermoplastic acrylate-based polymers, preferably the polymers comprise homo- or co-polymers of acrylate-based polymers, such as for example. polymethyl methacrylate (PMMA) or co-polymers with styrene, and whose cores comprise elastomers, in particular elastomeric polymers or mixtures of elastomeric polymers, in particular rubbers, such as synthetic rubbers, silicones and/or polyacrylates, preferably the TG of the acrylates is below 0° C., particularly preferably the TG of the polyacrylates is below 0° C., in particular the elastomeric polymers comprise homo- or co-polymers, and
D) 0 to 2550 parts by weight of inorganic filler, in particular 0 to 850, alternatively preferably from 10 to 1500 parts by weight of inorganic filler,
E) 0 to 300 parts by weight of one or more substances selected from the group consisting of pigments, x-ray opacifiers, stabilizers, regulators, antimicrobial additives, UV absorbers, UV and/or Vis stabilizers (UV/Vis absorbers), catalysts and crosslinkers.

The object of the invention is a thermoplastic composition comprising
A) from 50 to 5000 parts by weight, in particular from 50 to 2500, preferably from 50 to 950 parts by weight, of poly(dialkylphenylene) ethers with alkyl having 1 to 6 carbon atoms, in particular poly(2,6-dialkyl-1,4-phenylene) ethers and optionally poly(2,6-dialkyl-1,3-phenylene) ethers or mixtures thereof, in each case independently with alkyl having 1 to 6 carbon atoms,
B) 100 parts by weight of thermoplastic styrene polymer, in particular a homo- or co-polymer of a styrene polymer,
C) 5 to 1500, in particular 10 to 850, parts by weight of core-shell particles, wherein the shell of the core-shell particles comprises thermoplastics, in particular thermoplastic acrylate-based polymers, preferably the polymers comprise homo- or co-polymers of acrylate-based polymers, such as, for example, polymethyl methacrylate (PMMA) or co-polymers with styrene, and whose cores comprise elastomers, in particular elastomeric polymers or mixtures of elastomeric polymers, in particular rubbers, such as synthetic rubbers, silicones and/or polyacrylates, preferably the TG of the acrylates is below 0° C., particularly preferably the TG of the polyacrylates is below 0° C., in particular the elastomeric polymers comprise homo- or co-polymers, and
D) 0 to 2550 parts by weight of inorganic filler, in particular 0 to 850, alternatively preferably from 10 to 1500 parts by weight of inorganic filler,
E) contains 0 to 300 parts by weight, in particular 2 to 100 parts by weight, of one or more substances selected from the groups consisting of pigments, x-ray opacifiers, stabilizers, regulators, antimicrobial additives, UV-absorbers, UV- and/or Vis-stabilizers (UV/Vis-absorbers), catalysts and crosslinkers.

The thermoplastic composition according to the invention is preferably a medical, dental, veterinary thermoplastic composition. Also an object of the invention is a thermoplastic composition for use as a medical product, in particular as a medical device, in particular for the manufacture of medical prostheses, instruments, apparatuses and parts thereof. Poly(dialkylphenylene) ethers are understood to be poly(dialkylphenylene) ethers with alkyl having 1 to 6 C atoms, which in particular comprise poly-(2,6-dialkyl-1,4-phenylene) ethers and optionally poly-(2,6-dialkyl-1,3-phenylene) ethers or mixtures thereof, wherein alkyl may each independently have 1 to 6 C atoms.

Preferably, the poly(dialkylphenylene) ethers comprise greater than or equal to 50% by weight, in particular greater than or equal to 85 wt.-%, of poly(2,6-dialkyl-1,4-phenylene) ethers and optionally less than 50 wt.-%, preferably less than 15 wt.-%, of poly(2,6-dialkyl-1,3-phenylene) ethers with respect to the total composition of poly(dialkylphenylene) ether. The poly(dialkylphenylene) ethers according to the invention comprise poly-(2,6-alkyl-1,4-phenylene) ethers, poly-(2,6-dialkyl-1,3-phenylene) ethers and/or mixtures thereof, in particular from 80 to 100 wt.-%, preferably from 90 to 100 wt.-%, of poly(2,6-dimethyl-1,4-phenylene) ether and from 0 to 20 wt.-%, in particular from 0 to 10 wt.-%, of poly(2,6-dimehthyl-1,3-phenylene) ether, based on the total amount of poly(dialylphenylene) ether. The poly(dialkyl phenylene) ethers according to the invention comprise poly(2,6-alkyl-1,4-phenylene) ethers, poly(2,6-dialkyl-1,3-phenylene) ethers and/or mixtures thereof, in particular from 80 to 99 wt.-%, preferably from 90 to 99 wt.-%, poly(2,6-dimethyl-1,4-phenylene) ether and from 1 to 20% by weight, in particular from 1 to 10 wt.-%, of poly(2,6-dimehthyl-1,3-phenylene) ether, based on the total amount of poly(dialylphenylene) ether. The alkyl groups with 1 to 6 C atoms can be linear, branched or cyclic, alkyl groups with 1 to 3 C atoms are preferred, in particular methyl, ethyl, n-popyl and/or iso-propyl groups.

Where polymers are mentioned, the term polymers shall be understood to comprise both homo- and co-polymers. Furthermore, the polymers may be present as random polymers, block co-polymers, with any tacticity, such as isotactic or atactic, syndiotactic.

TG is the glass transition temperature, also T_{g}. TG can be measured using the methods listed below. DMA and DSC are commonly used. Dynamic Mechanical Analysis (DMA) measures a change in E and G modulus, a maximum of the change in attenuation in a narrow temperature range. The standard deviation can be several degrees Celsius (C). With usually used DSC method (dynamic differential calorimetry) heat capacity Cₚ is determined as a function of temperature. Since heat capacities of liquid and glassy phases differ, a continuous transition can be measured near the glass transition temperature. The determined glass transition temperature depends on the heating and cooling rates. If heating or cooling occurs, the determined values from the heating or cooling process converge. However, the heat capacity is more difficult to measure at low heating/cooling speeds. The standard deviation is significantly lower than with DMA and is usually one and a half to two degrees Celsius between about 100 and 200 degrees Celsius.

Poly-(2,6-dialkyl-1,4-phenylene) ethers with alkyl with 1 to 6 C atoms are all structural isomers of polyethers, i.e. with linear or branched alkyl groups, such as poly-(2,6-dimethyl-1,4-phenylene) ether, poly-(2,6-diethyl-1,4-phenylene) ether, poly-(2,6-dipropyl-1,4-phenylene) ether, poly-(2,6-di-n-propyl-1,4-phenylene) ether, Poly-(2,6-di-iso-propyl-1,4-phenylene) ether, Poly-(2,6-dibutyl-1,4-phenylene) ether, Poly-(2,6-di-n-butyl-1,4-phenylene) ether, Poly-(2,6-di-tert-butyl-1,4-phenylene) ether, poly-(2,6-di-iso-butyl-1,4-phenylene) ether, poly-(2,6-dipentyl-1,4-phenylene) ether, poly-(2,6-dihexyl-1,4-phenylene) ether, poly-(2,6-di-cyclohexyl-1,4-phenylene) ether. Poly-(2,6-dimethyl-1,4-phenylene) ether is particularly preferred. Available is poly-(2,6-dimethyl-1,4-phenylene) ether from the reaction of 2,6-xylenol by oxidation polymerization, as disclosed for example in U.S. Pat. No. 3,661,848. Correspondingly, poly-(2,6-dialkyl-1,3-phenylene) ether, preferably poly-(2,6-dimethyl-1,3-phenylene) ether. Terminal end groups may comprise H—, alkyl-O—, HO—, with alkyl having 1 to 25 C atoms, preferably having 1 to 6 C atoms, and/or with aryl-O— groups having 6 to 20 C atoms, such as phenyl-O—.

Preferred thermoplastic compositions comprise as component A) a poly(dialkylphenylene) ether with alkyl having 1 to 6 C atoms, in particular poly(2,6-dimethyl-1,4-phenylene) ether optionally containing poly(2,6-dimethyl-1,3-phenylene) ether, the poly(dialkylphenylene) ethers having a molecular weight Mw of from 60,000 to 180,000, in particular from 70,000 to 130,000. The ratio of Mw/Mn can be in the range of 2.0 to 7.0, preferably from 3 to 6.7. The determination is carried out by known methods using GPC. For example, the determination of the molecular weight can be done by Malvern Pananalytic OMNISEC (light scattering (LALS or RALS), column (styrene-divinylbenzene columns (SDVB) for organic soluble synthetic polymers), solvent: for example, one or mixture of THF, DMF, chloroform, HFIP or optionally toluene, xylene, acetone, MEK, DMAc, NMP. In the specific case, the molecular weight (Mw, Mn) of the polyphenylene ethers was dissolved in chloroform 0.2 g/dl. The calibration curve was prepared using standard polystyrene with Showa Denko Co, Ltd. gel permeation chromatography system 21. Standard polystyrene has molecular weight of 3650000, 217000, 1090000, 681000, 204000, 52000, 30200, 13800, 3360, 1300 and 550. Two columns K-805L of Showa Denko K.K. were used in series (solvent: chloroform, solvent flow rate: 1.0 ml/min, column temperature: 40° C., detection unit: UV wavelength 254 nm for standard polystyrene and 283 nm for polyphenylene ether).

A preferred thermoplastic composition comprises,
A) 50 to 2500 parts by weight of poly(dialkylphenylene) ether with alkyl having 1 to 6 carbon atoms,
B) 100 parts by weight of thermoplastic styrene polymer,
C) 10 to 850 parts by weight core-shell particles,
D) 0 to 850 parts by weight of inorganic filler, and optionally
E) one or more substances selected from the group consisting of pigments, x-ray opacifiers, stabilizers, regulators, antimicrobial additives, UV absorbers, UV/Vis stabilizers or UV/Vis absorbers, catalysts and crosslinkers, wherein
E) is preferably 0.001 to 1500 parts by weight, in particular up to 300 parts by weight, of pigment, x-ray opaque and/or UV/Vis stabilizer.

According to another preferred embodiment, there is disclosed a thermoplastic composition comprising
A) 100 to 2500 parts by weight, in particular 200 to 500 parts by weight, of poly(dialkylphenylene) ether with alkyl having 1 to 6 carbon atoms,
B) 100 parts by weight of thermoplastic styrene polymer,
C) 10 to 850 parts by weight of core-shell particles, in particular 100 to 450 parts by weight,
D) 0 to 1500 parts by weight, in particular 10 to 850, preferably 50 to 850, particularly preferably 100 to 450 parts by weight, of inorganic filler, in particular 1 to 95 parts by weight, and optionally
E) 0.001 to 300 parts by weight of pigment, x-ray opaque and/or UV/Vis stabilizer.

According to another preferred embodiment, there is disclosed a thermoplastic composition comprising,
A) 120 to 1500 parts by weight of poly(dialkylphenylene) ether with alkyl having 1 to 6 carbon atoms,
B) 100 parts by weight of thermoplastic styrene polymer,
C) 10 to 950 parts by weight core-shell particles,
D) 15 to 950 parts by weight of inorganic filler, and optionally
E) 0.001 to 95 parts by weight of pigment, x-ray opaque and/or UV/Vis stabilizer.

Further, a thermoplastic composition is preferred which comprises
A) 100 to 500 parts by weight of poly(dialkylphenylene) ether with alkyl having 1 to 6 carbon atoms,
B) 100 parts by weight of thermoplastic styrene polymer,
C) 20 to 300 parts by weight of core-shell particles,
D) 0 to 300 parts by weight of inorganic fillers, in particular 15 to 300 parts by weight, and optionally
E) 0.001 to 200 parts by weight of pigment, x-ray opaque and/or UV/Vis stabilizer.

Further, a thermoplastic composition is preferred which comprises
A) 150 to 900 parts by weight of poly(dialkylphenylene) ether with alkyl having 1 to 6 carbon atoms,
B) 100 parts by weight of thermoplastic styrene polymer,
C) 20 to 300 parts by weight of core-shell particles,
D) 0 to 300 parts by weight of inorganic fillers, in particular 10 to 850, preferably 50 to 850, particularly preferably 100 to 450 parts by weight, and optionally
E) 0.001 to 200 parts by weight of pigment, x-ray opaque and/or UV/Vis stabilizer.

Likewise, it is an object of the invention to provide a thermoplastic composition comprising 30 to 96.99% by weight of polymer alloy of A) poly(dialkylphenylene) ether with alkyl having 1 to 6 carbon atoms and B) 5 to 30% by weight (wt.-%) of thermoplastic styrene polymer, A) and B) being present in the polymer alloy in a mass ratio of 90 to 10 to 40 to 60, preferably A) to B) being present in a mass ratio of 85 to 15 to 60 to 40, preferably 75 to 85 to 20 to 65 to 75, particularly preferably 80 to 20 to 70 to 30,
3 to 30 wt.-% core-shell particles as C),
0 to 55 wt.-% inorganic fillers as D), in particular 2 to 30 wt.-%, and optionally 0.01 to 40 wt.-% pigment, X-ray opaque and/or UV/Vis stabilizer as E), the total composition being 100 wt.-%.

Preferably, a thermoplastic composition comprising, 30 to 96.99% by weight of polymer alloy of A) poly(dialkylphenylene) ether with alkyl having 1 to 6 carbon atoms and B) 5 to 30% by weight of thermoplastic styrene polymer, A) and B) being present in the polymer alloy in a mass ratio of 90 to 10 to 40 to 60, preferably A) to B) being present in a mass ratio of 85 to 15 to 60 to 40, preferably 75 to 85 to 20 to 65 to 75, particularly preferably 80 to 20 to 70 to 30, 3 to 20 wt.-% core-shell particles as C), optionally 10 to 35 wt.-% inorganic fillers as D), in particular 10 to 30 wt.-%, and optionally 0.01 to 40 wt.-% pigment, X-ray opaque and/or UV/Vis stabilizer as E), the total composition being 100 wt.-%.

Further preferred are thermoplastic compositions comprising core-shell particles selected from core-shell particles wherein i) the shell of the core-shell particles comprises polymers of acrylate and/or methyl acrylate and/or methyl methacrylate and/or methylmethacrylate and styrene, and ii) the core of the core-shell particles comprises a) polymers comprising butadiene having a TG less than −10° C., preferably TG less than −50° C., particularly preferably TG less than −70° C., polymers comprising acrylate having a TG less than −10° C. preferably TG less than −30° C., particularly preferably TG less than −50° C., polymers comprising silicone rubber (graft copolymers) having a TG less than −10° C., polymers comprising silicone rubber with a TG less than −10° C., polymers comprising polyurethane polymers with a TG less than −10° C., polymers comprising polydimethylsiloxane with a TG less than −10° C., polymers comprising epoxy-functionalized polymers with a TG less than −10° C., or the core of the core-shell particles comprises b) an elastic phase selected from poly(n-butyl acrylates) (PBA), butadiene-styrene copolymers, nitrile-butadiene copolymers, silicone rubber (graft copolymers), polyurethane polymers, polyolefin-based polyurethanes (polybutadiene-based polyurethanes, polydimethylsiloxane modified polyurethanes, epoxy-functionalized elastic phases.

Particularly preferred core-shell particles are selected from core-shell particles comprising
i) 10 to 60% by weight, in particular 10 to 50% by weight, of shell comprising methyl methyacrylate-styrene polymers or polymethyl methacrylate or polymers of acrylate or of methyl acrylate or of methyl methacrylate or mixtures thereof, in particular selected from these polymers, polymethyl methacrylate being particularly preferred, and
ii) 40 to 90% by weight, in particular 50 to 90% by weight, core comprising acrylate-based polymers, in particular butyl acrylate-based polymers and/or acrylate butadiene silicone polymers or mixtures thereof, preferably poly-(n-butyl acrylate) (PBA) or polymers as mentioned above under a), the core and shell of the core-shell particles being 100% by weight. Preferably, the shell completely encases the core. Preferably, the shell forms a shell around the core. Particularly preferred core-shell particles are selected from core-shell particles having polymethyl methacrylate shell and poly-(n-butyl acrylate) core. In particular, the core-shell particles have a refractive index of 1.45 to 1.55.

Particularly preferred are core-shell particles with a polymeric shell based on methyl methyacrylate-styrene polymers or polymethyl methacrylate and a core comprising acrylate-based polymers, in particular butyl acrylate-based polymers and/or acrylate-butadiene-silicone polymers or mixtures thereof. Alternatively preferred are core-shell particles having a core comprising acrylate polymers with a TG less than −50° C. and a shell comprising acrylate polymers, in particular with a TG greater than 0° C. Preferred particle sizes are in the range of 50 nm to 500 microns, in particular from 50 nm to 10 microns or alternatively from 100 microns to 300 microns. The core-shell particles are preferably present as a powder.

Component B), the thermoplastic styrene polymer, is preferably selected from polystyrene, copolymers of styrene and butadiene, copolymers of styrene and isoprene, copolymers of styrene and esters of fumaric acid, copolymers of styrene and esters of acrylic acid, and mixtures of at least two of the above polymers. A thermoplastic polystyrene polymer, i.e. a homopolymer, is particularly preferred.

Component D) preferably comprises as inorganic filler silicon dioxide, quartz, kaolin, zirconium dioxide, mixed oxides of zirconium dioxide, pyrogenic or precipitated silicas, dental glasses such as aluminosilicate glasses or fluoroaluminosilicate glasses, barium aluminum silicate, strontium silicate, strontium borosilicate, lithium silicate, lithium aluminum silicate, phyllosilicates, zeolites, amorphous spherical fillers based on oxides or mixed oxides, in particular mixed oxides of SiO₂ and ZrO₂, glass fibers and/or carbon fibers, as well as defined mixtures comprising at least two of the above-mentioned inorganic fillers.

Component E) preferably comprises, as pigments, organic dyes: Titanium dioxide, carbon black, dyes, etc.

Alternatively or additionally, component E) may comprise X-ray opaques, in particular with heavy atoms, such as preferably alkaline earth metal(s), lanthanodi(s) whose atomic mass is greater than or equal to 85 u, preferably greater than or equal to 120 u, or alternatively greater than or equal to 85 g/mol, preferably greater than or equal to 120 g/mol and, which are preferably not already present in the filler and/or in the dental glass. Preferred X-ray opaques comprise atoms of the 5, 6 to 7 period of the periodic table of elements, preferably of the 6 and 7 period of the periodic table of elements, such as ytterbium, barium, tungsten, niobium. Preferred X-ray opaques preferably comprise salts or oxides of these, such as in particular ytterbium salts, in particular halogen salts of ytterbium, such as ytterbium trifluoride (YbF₃), alternatively preferred can also be barium salts, such as barium sulfate (BaSO₄), calcium tungsten oxides (CaWO₄) and niobium oxides, (Nb₂O₅).

Furthermore, component E) preferably comprises at least one UV/Vis stabilizer, in particular a 2-hydroxyphenyl-s-triazine. UV/Vis-stabilizer is understood to mean a UV-stabilizer with an absorption maximum in the range from 180 to 249 nm or UV- and Vis-stabilizer with an absorption maximum in the range from 180 to 450 or Vis stabilizer with an absorption maximum in the range from 250 to 450 nm. In general, hydroxyphenyl and/or methoxyphenyl substituted ketones, or methoxysubstituted quinones or derivatives thereof are suitable UV/VIS stabilizers. Suitable UV/Vis stabilizers comprise: 2-hydroxyphenyl-s-triazine derivative, such as 3-(diaryl-[1,3,5]triazin-2-yl)-5-(alkoxy-substituted) phenol and/or 2-(2H-benzotriazol-2-yl)-4,6-diterpentylphenol and/or 2-hyroxy-4-methoxybenzophenones. As suitable UV- and Vis-stabilizers, 2-hydroxyphenyl-s-triazine derivative, such as 3-(diaryl-[1,3,5]triazin-2-yl)-5-(alkoxy-substituted)-phenol, 2-hyroxy-4-methoxybenzophenone, hydroquinone mono methyl ether and/or 2,6-di-tert.-butyl-4-methylphenol (BHT) may be present in the thermoplastic composition. Preferably, the stabilizer is present at 1 to 5 parts by weight per 100 parts by weight of the total parts by weight of the total composition.

According to one embodiment, the object of the invention is a composition, in particular a polymer blend, comprising 50 to 6000 parts by weight of a further thermoplastic polymer, in particular the further polymer is not a poly(dialkylphenylene) ether and not a styrene polymer or a mixture thereof. Particularly preferably, the further thermoplastic polymer comprises polystyrene, polyethylene, polypropylene, polyamide or a blend comprising one or at least two of the polymers. In an alternative, the further thermoplastic polymer is selected from polystyrene, polyethylene, polypropylene, polyamide, or a blend of at least two of the polymers.

Also subject to the invention is a process for preparing a composition and a thermoplastic composition obtainable by the process, wherein the thermoplastic composition can be prepared:
i) by mixing
A) 5 to 5000 parts by weight of poly(dialkylphenylene) ether with alkyl having 1 to 6 carbon atoms
B) 100 parts by weight of thermoplastic styrene polymer,
C) 0.001 to 1500 parts by weight core-shell particles,
D) 0 to 2550 parts by weight of inorganic filler, and
E) 0.001 to 300 parts by weight of pigment, X-ray opaque and/or UV/Vis stabilizer, obtaining a mixture comprising A), B), C), D) and E) and heating the mixture to a temperature above the softening temperature of A) poly(dialkylphenylene) ethers with alkyl having 1 to 6 carbon atoms and obtaining a thermoplastic composition comprising A), B), C) and D) and/or E), or
ii) by mixing
A) 5 to 5000 parts by weight of poly(dialkylphenylene) ether with alkyl having 1 to 6 carbon atoms,
B) 100 parts by weight of thermoplastic styrene polymer and obtaining a mixture comprising A) and B) and heating the mixture to a temperature above the softening temperature of A) poly(dialkylphenylene) ether with alkyl having 1 to 6 C atoms and producing a homogeneous mass comprising A) and B), and mixing the homogeneous mass of A) and B) with C) 0.001 to 1500 parts by weight of core-shell particles, D) 0 to 2550 parts by weight of inorganic filler(s) and E) 0.001 to 300 parts by weight of pigment(s), X-ray opaque(s) and/or UV/Vis stabilizer(s), and obtaining a mixture comprising the homogeneous mass, C), D) and/or E) and heating the mixture to a temperature above the softening temperature of the A) poly(dialkylphenylene) ether with alkyl having 1 to 6 C atoms and producing the thermo plastic composition comprising A), B), C) and D) and/or E), or
iii) by mixing
A) 5 to 5000 parts by weight of poly(dialkylphenylene) ether with alkyl having 1 to 6 carbon atoms,
B) 100 parts by weight of thermoplastic styrene polymer, and
C) 0.001 to 1500 parts by weight of core-shell particles, and obtaining a mixture comprising A), B) and C) and heating the mixture to a temperature above the softening temperature of A) poly(dialkylphenylene) ether with alkyl having 1 to 6 C atoms and producing a homogeneous mass comprising A), B) and C), in a further step the homogeneous mass of A), B) and C) is mixed with D) 0 to 2550 parts by weight of inorganic filler and/or E) 0.001 to 300 parts by weight of pigment, X-ray opaque and/or UV/Vis stabilizer, and obtaining a mixture comprising the homogeneous mass, D) and/or E) and heating the mixture to a temperature above the softening temperature of the A) poly(dialkylphenylene) ether with alkyl having 1 to 6 C atoms and producing the thermoplastic composition comprising A), B), C) and D) and/or E).

It may be preferred to dry the components separately or in mixtures prior to use in the process. Typical drying conditions occur in the temperature range of 80 to 150 degrees Celsius, preferably around 100 degrees Celsius, for a period of 10 minutes to 48 hours, preferably for about 1 to 5 hours. Therefore, components A), B), C), D) and/or E), the core-shell particles and/or the inorganic filler and optionally the UV/Vis stabilizer are preferably dried before mixing and/or the mixture of A) and B), mixture of A), B), C), D), and E), the mixture of A), B) and C), the homogeneous compound comprising A), B), C), D) and/or E), the homogeneous compound comprising A) and B), the homogeneous compound comprising A), B) and C) is preferably dried before heating.

Furthermore, object of the invention is a thermoplastic molded article obtainable by processing a thermoplastic composition or a thermo plastic composition obtained by the process in an extruder, in particular in a double screw extruder, at elevated temperature, in particular at a temperature above the softening temperature of the A) poly(dialkalphenylene) ether, in particular poly(2,6-dialkyl-1,4-phenylene) ether, poly(2,6-dialkyl-1,3-phenylene) ether or mixtures thereof, is processed and then molded and optionally cooled, in particular processed into a molded article and optionally cooled. Preferably, the thermoplastic composition is processed at above 150 degrees Celsius and then molded and optionally cooled, obtaining a thermoplastic molded body. Preferably, the production of the thermoplastic composition and/or the production of thermoplastic molded bodies is carried out in an extruder, preferably a twin-screw extruder or an injection molding process in the temperature range of 200 to 300° C., preferably at 250 to 280° C. in an extrusion process and at 275 to 315° C. in an injection molding process.

A thermoplastic molded body can have any geometry, preferably the thermoplastic molded body is in the form of a milled blank, cylindrical milled blank, as granules, tubular molded body, pellet, bead, polyhedron, cuboid, cylinder, sphere, three-dimensional molded body with polyhedral basic structure and at least one curved surface, medical prosthetic product, dental prosthetic mold, dental prosthesis, clasp prosthesis, part of prosthesis, bite splint, drill template for implantology, mouthguard, artificial joint prosthesis, crown, telescope, veneer, dental bridge, prosthetic tooth, implant, implant part, abutment, suprastructure, orthodontic apparatus, medical instrument, veterinary prosthesis, hoof prosthesis. The thermoplastic molded article is preferably obtainable by an extrusion process, injection molding process or laser sintering process.

The thermoplastic composition or a thermoplastic molded article preferably exhibits a total energy of rupture of ≥5000 J/m² (ISO 20795-1; 2013-06), in particular as a thermoplastic composition or a thermoplastic molded article without inorganic fillers. Alternatively, a thermoplastic composition or a thermoplastic molded article with a content of inorganic fillers and/or pigments exhibits at least 100 J/m² (ISO 20795-1; 2013-06) as total energy to break or higher, in particular compared to a thermoplastic composition or a thermoplastic molded article with the same content of inorganic fillers and/or pigments without core-shell particles.

Furthermore, the object of the invention is thermoplastic compositions for use as a medical product, in particular as a medical device, in particular for the manufacture of medical products, medical prostheses, instruments, apparatuses and/or parts thereof, for the manufacture of thermoplastic three-dimensional molded bodies, medical prosthetic products, dental prosthetic molded bodies, for the manufacture of dental prostheses, clasp prostheses, parts of prostheses, for the manufacture of bite splints, of drilling templates for implantology, of mouthguards, orthopedic prostheses or parts thereof, such as bone replacement prostheses, in particular vertebral bodies, jaw bones or parts thereof, artificial joint prostheses, such as endoprostheses, crowns, telescopes, veneers, dental bridges, denture teeth, implants, in particular jaw implants, implant parts, in particular jaw implants, abutments, superstructures, orthodontic appliances and instruments, in the veterinary field for the production of prostheses, for the production of granules for use in laser sintering processes, in particular for the production of three-dimensional shaped bodies. Furthermore, it is an object of the invention to use the thermoplastic composition or to use granules of the thermoplastic composition in injection molding processes, laser sintering processes, Variotherm, hot embossing or hot pressing processes. Medical products, in particular medical devices, are 93/42/EEC, 90/385/EEC, VO 2017/745. It is also an object of the invention to use the thermoplastic composition as a medical product, in particular the aforementioned medical products.

The thermoplastic composition or the molded article according to the invention, in particular a denture material made from the thermoplastic composition, preferably has a fracture toughness (kₘₐₓ; maximum factor of stress intensity) of greater than or equal to 2.0 MPa·m^{1/2}, in particular greater than or equal to 2.2 MPa·m^{1/2}, and preferably at the same time has a total energy to fracture (Wₜ) of greater than or equal to 1500 J/m². Particularly preferably, the fracture toughness is greater than or equal to (≥) 2.1 MPa·m^{1/2}, preferably ≥2.3 MPa m^{1/2}, ≥2.4 MPa·m^{1/2}. It is further preferred if the work of fracture is at the same time greater than ≥1500 J/m², in particular greater than or equal to ≥5000 J/m², ≥7000 J/m², particularly preferably greater than or equal to 8000 J/m². Particularly preferably, moreover, the flexural strength is also greater than 80 MPa, more preferably greater than 82 MPa, further preferably greater than or equal to 85 MPa. A particularly preferred thermoplastic composition or a thermoplastic molded article, in particular a prosthetic material, has a fracture toughness of >2.3 MPa*m^{1/2} and a total work of fracture of >1300 J/m².

The core-shell particles are also referred to as high-impact modifiers. Core-shell particles according to the invention are preferably added as a powder to the polymer alloy, in particular comprising A) and B) and optionally D). Preferably, the core-shell particles have an elastic core that has been functionalized with monomers to polymerize the shell and then the monomers have been polymerized. Alternatively, the core-shell particles may have an elastic core that has been grafted, in particular with an acrylate-based shell, preferably with a poly(meth)acrylate-based shell. A polymer blend is obtained by mixing or compounding two or more polymers or copolymers. The polymer blend has its own specific properties.

Particularly preferred thermoplastic compositions preferably comprise core-shell particles comprising a) core-shell particles having core of elastic phase in hard shell, i.e. outer shell, or b) the core-shell particles having multiple elastic phases as core in hard shell, or c) the core-shell particles having one elastic phase as core in multilayer shells. Preferably, the core or elastic phase(s) of the modified core-shell particles is selected from butyl acrylate in hard shell or hard shells of PMMA.

Furthermore, preferred core-shell particles have a refractive index similar to that of the modified polyether, i.e. components A) and B). Preferably, the refractive index of the core-shell particles is around 1.4900 with a variation range of plus/minus 0.02, in particular+/−0.01. Particularly preferred core-shell particles according to the invention are present as granules or powder. Preferably, the core-shell particles are present as a particulate solid, in particular as granules or powder. Preferably, the cores of the core-shell particles are spherical in shape, in particular made of said polymers, and are encased by at least one spherical shell, preferably a continuous shell made of said polymers. By enveloped is meant a substantially complete envelope. The spherical cores may also be encased by multiple spherical shells. The core-shell particles can be prepared via conventional aqueous emulsion polymerization processes or other polymerization processes known to those skilled in the art.

Primary particles of core-shell particles can be present aggregated in an alternative. In this case, the aggregates of core-shell particles, which may be irregularly shaped, have an average diameter d₅₀˜50-300 μm as an irregularly shaped aggregate. In one alternative, the preferred size of the primary particles is less than 500 nm, in particular up to 100 nm, preferably from 50 nm to 400 nm, particularly preferably from 200-400 nm. Likewise, core-shell particles with a primary particle size of less than or equal to 200 nm to 2 nm, such as between 150 to 10 nm can be used as core-shell particles. Preferred core-shell particles have a diameter d₅₀˜of 120 to 200 nm of the primary particles, which are preferably spherical in shape.

Core-shell particles according to the invention preferably have particle sizes of 50 nm to 300 micrometers. Particles with a particle size of less than 500 nm are referred to as primary particles and can form agglomerates. Preferably, the core-shell particles are present surrounded by A) and B) in the thermoplastic composition. Ideally, the core-shell particles are homogeneously distributed in the matrix of the thermoplastic composition and do not form aggregates.

Preferably, the core-shell particles have a refractive index of from 1.48 to 1.60, in particular from 1.49 to 1.55. Particularly preferably, the refractive index of the core-shell particles is in the range of the refractive index of the modified polyethers, thus preferably the refractive index is around 1.48 to 1.50.

Also preferred are core-shell particles whose density is from 0.9 to 1.5 g/ml, in particular from 0.95 to 1.4 g/ml. Preferably, the bulk density is at the same time from 0.1 to 0.9 g/ml, preferably from 0.2 to 0.7 g/ml.

A hard outer shell is understood to be a material which preferably has a lower elasticity than the material of the elastic phase (core). Preferably, the elasticity of the hard materials is at least 40% lower than that of the elastic phase. The organic hard materials of the shell suffer significantly less deformation under the action of a force than the elastic phase of the core. The hard materials as a hard shell, especially outer shell, stabilize the elastic phase in its shape. An elastic phase is formed from at least one elastic material that undergoes reversible deformation under the action of a force. Advantageously, the deformation of the elastic phase is fully reversible without the action of a force. Preferably, the elastic cores are formed from polymers whose glass transition points are well below room temperature.

Preferred core-shell particles preferably comprise in the elastic core as elastic phase at least one elastomer, such as rubbers, in particular a natural vulcanized rubber as soft rubber or rubber and/or synthetic rubber. Particularly preferably, the elastic phase of the elastic core is formed by thermoplastic elastomers or, preferably, thermoset elastomers. Preferably, the elastic phase, in particular the elastic core of the core-shell particle comprises a styrene-based copolymer and/or an acrylate-based polymer in particular comprising poly(n-butyl acrylate) PBA, preferably poly(butyl acrylate)-styrene copolymers and/or a synthetic rubber comprising butadiene-styrene copolymer, nitrile-butadiene copolymer, silicone rubber (graft copolymer), polydimethylsiloxanes, methyl- and aryl-substituted siloxanes, polyurethane polymer, polyolefin-based polyurethane (polybutadiene-based polyurethane), butadiene rubber, (BR), acrylonitrile-butadiene rubber (NBR), butyl rubber (IIR), ethylene propylene diene rubber (EPDM), chloroprene rubber (CR), isorprene rubber (IR), and/or mixtures comprising at least two of said synthetic rubbers. The particle size of the core-shell particles may be less than or equal to 500 nm, such as between 50 nm to 500 nm, in particular less than or equal to 400 nm to 100 nm. Alternatively, the elastic phase may be based on polydimethylsiloxane modified polyurethanes and/or epoxy functionalized elastic phases. The determination of the particle size as well as the core-shell structure can be carried out by means of TEM (transmission electron microscope) and/or SEM (scanning electron microscopy) optionally in combination with EDX energy dispersive X-ray spectroscopy). Particularly preferred is an elastic core of the core-shell particles comprising an acrylate-based polymer, in particular comprising poly-(n-butyl-acrylate) PBA, and a shell comprising polymethyl methacrylate. FIGS. 1 (SEM) and 2 (TEM) show images of the respective images of the agglomerated particles. In FIG. 2 with isolated core-shell particles, their core-shell structure is clearly visible. The particles investigated here have particle sizes of 338 to 225 nm.

Core-shell particles according to the invention preferably comprise as hard shell at least one acrylate polymer and/or (meth)acrylate polymer, preferably an alkyl (meth)acrylate polymer, such as methyl methacrylate polymer (PMMA, polymethyl methacrylate), and/or methyl methacrylate-styrene co-polymer, polystyrene as well as homo- or co-condensates of the aforementioned polymers. Preferably, the hard shell may comprise thermoplastics. Alternatively, the hard shell may comprise or be formed from at least one polybutadiene homo- or co-polymer. In these cases, the elastic phase of the core is a aforementioned synthetic rubber or an acrylate with a TG lower than −50° C. TG of the shell may preferably be greater than TG>5° C., preferably greater than 10° C.

Particularly preferred core-shell particles comprise an elastic core comprising acrylate polymers, in particular with TG less than −50° C., in particular less than −70° C., with a hard shell (outer shell), preferably of an acrylate polymer, in particular with a TG greater than 5° C., in particular with a primary particle size less than 250 nanometers. Also, suitable core-shell particles comprise an elastic core comprising a butadiene polymer, in particular with TG less than −50° C. with a hard shell (hard outer shell), in particular with a TG greater than 5° C., preferably made of a methyl methacrylate-styrene co-polymer, preferably with a primary particle size less than 250 nanometers. Further preferably, the core-shell particles have reactive groups towards polymerizable monomers, preferably the outer shell is functionalized with (meth)acrylate groups. The shell of the core-shell particles is considered to be a cladding layer or an envelope of the core with an acrylate polymer with a TG greater than 5° C., preferably of a methyl methacrylate-styrene co-polymer. The cladding layer or enveloper can be grafted or polymerized onto the core.

The respective TG, in particular of the core comprising acrylate polymers, preferably with TG less than −70° C., with hard shell (outer shell), preferably made of an acrylate polymer, preferably with a TG greater than 5° C. can be determined as defined below. The TG is to be understood as TG (total) for acrylate polymers comprising acrylate co-polymers.

TG (total) is determined via 1/TG (total) according to the following formula, where the acrylate monomers are present in the acrylate polymer according to the following weight proportions (w1, w2, w3, w4, w5 and wn).

$$1 / TG ( total ) = w 1 / {TG}_{( 1 )} + w 2 / {TG}_{( 2 )} + w 3 / {TG}_{( 3 )} + optional w 4 / {TG}_{( 4 )} + optional w 5 / {TG}_{( 5 )} + optional w n / {TG}_{( n )} ,$$

where w1, w2, w3, w4, w5 and wn are each weight fraction of the respective acrylate monomer in the acrylate polymer having a total composition of 100% by weight comprising first acrylate monomer and second acrylate monomer and optionally third acrylate monomer with n=1 to 10. The glass transition temperatures of co-polymers can be approximated using the Fox equation [Bullentin of the American Physical Society 1, 3 Page 123 (1956)].

The disclosed glass transition temperatures can be taken from the “polymer manuals” known to the skilled person, from the information provided by the manufacturers of the monomers. If no data on glass transition temperatures are available, they can be determined by DSC, DMS (dynamic mechanical analysis), dielectric relaxation spectroscopy or dilatometry. A common method is DSC measurement to determine the glass transition temperature of homopolymers. For this purpose, the homopolymer is dried, heated to 120° C., rapidly cooled to −100° C., and then heated to 150° C. or higher at 20° C./minute up to 300° C., and the glass transition temperature data is determined. The glass transition temperature is measured as an average value.

Also an object of the invention is a pigmented thermoplastic composition. Furthermore, it is an object of the invention to provide an unpigmented thermoplastic composition having a transparency greater than 85% (measured on 3 mm sheets). The core-shell particles preferably have a transparency greater than or equal to 85%, in particular greater than or equal to 90%.

All the above-mentioned components of the thermoplastic composition, such as pigment, stabilizer, filler, the respective component is present as pigment(s), stabilizer(s) or filler(s).

### EXAMPLES OF EMBODIMENTS

### Methods:

The measurements in Table 1 were carried out according to DIN EN ISO 20795-1 2013-06 (23±2° C., 50±10% relative humidity. Full reference is made to DIN EN ISO 20795-1 2013-06, i.e. the disclosure content is also disclosed. The specimens were manufactured from extruded flat bars.

Flexural strength specimen: height h_{f}=(3.3±0.2) mm and width b_{f}=10.0±0.2) mm were cut and all surfaces were wet-ground to specified dimensions with a grit size of 30 microns (P50000), 18 microns (P1000) and 15 microns (P1200).

Bending fracture test specimen: height h_{f}=(8.0±0.2) mm and width b_{f}=4.0±0.2 mm) length 39 mm-cut and all surfaces ground to specified dimensions by wet grinding process with grit size of 30 microns (P50000), 18 microns (P1000) and 15 microns (P1200).

The specimens are fixed in the holding fixture in the longitudinal direction. A mark is made on the center line at half the distance from the specimen edge. A pre-cut is made with a diamond blade and a saw (diamond saw blade (0.5±0.1 mm) to a depth of (3.0±0.2) mm along the centerline. Always 5 to 6 specimens are measured per method. Each specimen is clamped in the holding fixture. The pre-crack is moistened with a drop of glycerine.

The sharp blade is placed on the bottom of the crack and a notch depth of 100 microns to 400 microns is cut.

Flexural strength and E-modulus: Flexural strength (water bath 37° C.). Load ram force increased at constant crosshead speed (5±1 mm/min) until specimen breaks. Bend test fixture with center-mounted thick fin and two polished cylindrical supports, 3.2 mm in diameter and at least 10.5 mm long (No. 8.5.3.2.7).

Fracture toughness: bending jig (No. 8.6.3.7) with support span Iₜ (32.0±0.1 mm), bf=4.0±0.2) mm, h_{f}=(8.0±0.2) mm, a=0.1 to 0.4 mm longer than a′.
Flexural strength [MPa]: ISO 20795-I 2013-06 (No. 8.5.3.5.2.1).

Calculation:σ=3FI/2bh²
F=max. load on specimen in Newton
I=distance between supports, in mm, error limit±0.01 mm
b=width specimen, h=height specimen each before storage in water

E-modulus [MPa] (bending modulus): ISO 20795-I 2013 06 (No. 8.5.3.5.2.2). E=F I/4 b₁·^{3 . . . 3}. d h; F1=load in Newtons at a point in the straight portion (at maximum slope) of the load/deflection curve; d=deflection in mm at load F₁, I, b, h as above.

Maximum factor of stress intensity (fracture toughness, bending fracture) MPa m^{1/2}: ISO 20795-I 2013 06. Determination s. ch. 8.6, calculation s. ch. 8.6.5.2

Total energy to failure J/m²: ISO 20795-I 2013 06 (No. 8.6.5.3) with aforementioned test specimens.

Calculation of the total work of fracture.
W_{f}=U/(2b_{f}·(h_{f}−a)×1000 in J/m², where U=plotted area under the load/deflection curve represented by the following equation U=∫P·dΔ in Newton millimeters.
bf=4.0±0.2) mm, h_{f}=(8.0±0.2) mm, a=0.1 to 0.4 mm longer than
a′ with a′=(3.0±0.2) mm. Iₜ=(32.0±0.1) mm
Core-shell particles used: Kaneka M210 (acrylic-based core-shell particles); Kaneka IM 140 P; Kaneka M 732

### Extrusion:

The thermoplastic composition was produced in the ZSK 18 twin-screw extruder. Various manufacturing processes were carried out: PPO1: Components A) and B) were mixed in a tumbling mixer for 20 minutes and then dried at 100° C. for about 3 hours.

PPO2: components A), B), C) and optionally D) were dried separately at 100° C. for about 3 hours and then mixed (tumbling mixer).

PPO3: only polymer A) was dried at 100° C. for about 3 hours and then mixed with filler D) or pigment E) in a tumbling mixer for 20 minutes.

TABLE 1
Compounding the mixture

| | | | Temperature | | |
|---|---|---|---|---|---|
| | | | profile ° C. | | |
| | Speed | Throughput | T1-bis- | Torque | Mass |
| Mixture | rpm | kg/h | T4-T5-T6-TDüse | % | approx. |
| PPO1 | 450 | 5 | 250-260-260-270 | 62 | 1.2 kg |
| PPO2 | 450 | 5 | 250-260-260-270 | 58 | 1.2 kg |
| PPO3 | 450 | 5 | 250-260-260-270 | 63 | 1.4 kg |

When compounding PPO with filler, the outgoing melt pulsates, making pelletizing more difficult.

PPO1 was mixed with 5 wt.-% Kaneka B660 and 1600 g modified polymer (A)+B)).

PPO2 was mixed with 5 wt.-% Kaneka M210 and 1600 g modified polymer (A)+B)).

PPO3 was mixed with 15 wt.-% Nanofine G018053 sil. 300 nm and 1600 g modified polymer (A)+B)) mixed.

The process parameters in the twin screw extruder (co-rotating, 16 mm screw diameter) during compounding were as follows: Speed rpm: 450; Throughput kg/h: 5, Temperature profile in° C.: T₁-to T₄-T₅-T₆-T_{nozzle}: 250-260-260-270.

In the twin extruder, the composition is first premixed, followed by melting of the thermoplastic composition in the melting zone, and shearing and homogenization of the composition in the subsequent kneading zone. This is followed by a zone with vacuum to remove volatile components (8 mbar). Subsequently, the extrudate is expelled from the nozzle, cooled in a water bath and granulated in a granulator.

Injection molding: the compounded compositions PPO1, PPO2 and PPO3 were then processed into flat bars in an injection molding process (Arbug Allrounder 320 A-600-170). Before processing, the materials were dried at 100° C. for 3 hours. The flat bars were packed airtight in aluminum bags.

TABLE 2
Injection molding parameters

| | | | Spraying time/ | |
|---|---|---|---|---|
| | Cylinder | Mold | spraying | Cycle time/ |
| | temperature | temperature | pressureₘₐₓ | Shot weight |
| | [° C.] | [° C.] | [° C.] | approx. |
| PPO1 | 285-300 | 100 | Approx. 1 s/1960 bar | 52 s/17.15 g |
| PPO2 | 285-300 | 100 | Approx. 1 s/2260 bar | 52 s/17.15 g |
| PPO3 | 285-300 | 100 | Approx. 1 s/1630 bar | 52 s/17.15 g |

For the production of the granules from which the test specimen was made, the extruder was heated to 290° C. The mixture is placed in the compounder and mixed for 30 seconds 2 min at 100 rpm screw rotation and then removed with the injection molding container.

Injection molding Heating of the container to 270° C. and the mold to 60° C. Injection was carried out with a pressure of 10/7 bar and 10 sec with 12/6 bar.

TABLE 3
Preparation of thermoplastic compositions in twin-screw extruder, production
of PK's: injection molding, mPPE (poly-(2,6-dimethyl-1,4-phenylene)
ether modified with styrene polymer) - content in wt.-% with approx. 1
wt.-% stabilizer (UV/Vis stabilizer) in total composition (100 wt.-%)

| | | | | | | | | Total- |
|---|---|---|---|---|---|---|---|---|
| | | | Proportion | inorganic | flexural | E- | Bending | Energy to |
| | | | core-shell | filler | strength* | modulus* | fracture | failure* |
| | mPPE | Core-shell | [wt.-%] | [wt.-%] | [MPa] | [MPa] | MPa m^{1/2} | J/m² |
| VG1 | 80/20 | — | 0.00 | | 99.3 | 2321 | 3.60 | 4384 |
| VG2 | 70/30 | — | 0.00 | | 98.4 | 2347 | 3.55 | 4581 |
| Ex. 1 | 70/30 | Kaneka | 5.00 | | 92.6 | 2028 | 3.62 | 5822 |
| | | M210 | | | | | | |
| Ex. 2 | 70/30 | M 210 | 15.00 | | 88 | 1871 | 3.83 | 9962 |
| Ex. 3 | 70/30 | IM 140 P | 15.00 | | 80.4 | 1846 | 3.45 | 8342 |
| Ex. 4 | 70/30 | M 732 | 15.00 | | 81.7 | 1814 | 2.9 | 4648 |
| Ex. 5 | 70/30 | M 210 | 15.00 | 42 (SiO)₂ | 88.1 | 2862 | 2.48 | 1536 |
| VG3 | 70/30 | | 0.00 | 50 (SiO)₂ | 101.6 | 4632 | 3.03 | 1243 |
| Ex. 6 | 80/20 | M 210 | 15.00% | | 86.68 | 2038.8 | 4.02 | 14353 |

*determined according to ISO 20795-1; [1] inorganic filler: glass G018053 silanized 300 nm

The mechanical properties of a PMMA (polymethyl methacrylate) modified with core-shell particles, shown in Table 4 below, demonstrate a significant improvement in flexural fracture and overall workability.

TABLE 4
Production of thermoplastic compositions in twin-screw extruder,
production of PK's: injection molding, PMMA (amorphous)

| | | PMMA 7N - 10 wt.-% |
|---|---|---|
| | PMMA 7N | Kaneka M210 |
| Flexural strength [MPa] | 76.2 | 67 |
| MPa (ISO 20795-1) | | |
| E-modulus/MPa (ISO 20795-1) | 2362 | 1947 |
| Flexural strength/ | 1.93 | 2.61 |
| MPa/m^{1/2} (ISO 20795-1) | | |
| Total energy to | 397 | 2186 |
| failure*/J/m² (ISO 20795-1) | | |

The thermoplastic composition according to the invention shows a significantly improved overall fracture work compared to all comparative examples. The total energy to failure of thermoplastic compositions with a proportion of inorganic fillers can be significantly improved by adding core-shell particles.

1. Thermoplastic composition, wherein the composition comprises
A) 5 to 5000 parts by weight of poly(dialkylphenylene) ether, in particular poly(2,6-dialkyl-1,4-phenylene) ether, poly(2,6-dialkyl-1,3-phenylene) ether and/or mixtures thereof, wherein alkyl comprising 1 to 6 carbon atoms,
B) 100 parts by weight of thermoplastic styrene polymer,
C) 10 to 1500 parts by weight of core-shell particles, wherein the shell of the core-shell particles comprises thermoplastics and the core comprises elastomers, and
D) 0 to 2550 parts by weight of inorganic filler,
wherein the core-shell particles having
i) as a shell of the core-shell particles comprising polymers of acrylate, methyl acrylate and/or methyl methacrylate, and
ii) the core of the core-shell comprising polymers comprising acrylate having a TG less than-50° C., or the core of the core-shell particles having an elastic phase selected from selected from poly(n-butyl acrylates) (PBA).

2. Composition according to claim 1, wherein
C) the shell of the core-shell particles comprises thermoplastic acrylate-based polymers and the core comprises elastic polymers or mixtures of polymers whose TG is below 0° C.

3. Composition according to claim 1, wherein
A) the poly(dialkylphenylene) ethers comprise poly(2,6-alkyl-1,4-phenylene) ethers, poly(2,6-dialkyl-1,3-phenylene) ethers and/or mixtures thereof.

4. Composition according to claim 1, wherein that
the composition comprises
A) 50 to 2500 parts by weight of poly(dialkylphenylene) ether, wherein alkyl comprises 1 to 6 carbon atoms,
B) 100 parts by weight of thermoplastic styrene polymer,
C) 10 to 850, in particular parts by weight of core-shell particles, wherein the shell of the core-shell particles comprises thermoplastic acrylate-based polymers and the core comprises elastic polymers or mixtures of polymers whose TG is below 0° C., and
D) 0 to 1500, in particular 50 to 850, parts by weight of inorganic filler.

5. Composition according to claim 1, wherein the composition comprises
A) 100 to 2500 parts by weight of poly(dialkylphenylene) ether, wherein alkyl having 1 to 6 carbon atoms
B) 100 parts by weight of a thermoplastic styrene polymer,
C) 10 to 850 parts by weight of core-shell particles,
D) 0 to 1500 parts by weight of inorganic fillers, and optionally
E) 0.001 to 300 parts by weight of pigment, x-ray opaque and/or UV/Vis stabilizer.

6. A composition according to claim 1, wherein the composition comprises
A) 120 to 1500 parts by weight of poly(dialkylphenylene) ether, wherein alkyl has 1 to 6 carbon atoms,
B) 100 parts by weight of a thermoplastic styrene polymer,
C) 10 to 950 parts by weight of core-shell particles,
D) 0 to 950 parts by weight of inorganic fillers, and optionally
E) 0.001 to 95 parts by weight of pigment, x-ray opaque and/or UV/Vis stabilizer.

7. Composition according to claim 1, wherein, the composition comprises
A) 100 to 500 parts by weight of poly(dialkylphenylene) ether, wherein alkyl has 1 to 6 carbon atoms,
B) 100 parts by weight of a thermoplastic styrene polymer,
C) 20 to 300 parts by weight of core-shell particles,
D) 0 to 300 parts by weight of inorganic fillers, and optionally
E) 0.001 to 200 parts by weight of pigment, X-ray opaque and/or UV/Vis stabilizer.

8. (canceled)

9. Composition according to claim 1, wherein
B) the thermoplastic styrene polymer is selected from polystyrene, copolymers of styrene and butadiene, copolymers of styrene and isoprene, copolymers of styrene and esters of fumaric acid, copolymers of styrene and esters of acrylic acid and/or mixtures of at least two of the aforementioned polymers.

10. Composition according to claim 1, wherein the
D) inorganic fillers comprise silica, quartz, kaolin, zirconia, mixed oxides of zirconia, pyrogenic or precipitated silicas, dental glasses such as aluminosilicate glasses, fluoroaluminosilicate glasses, fluorobarium aluminosilicate, strontium silicate, strontium borosilicate, lithium silicate, lithium aluminum silicate, phyllosilicates, zeolites, amorphous spherical fillers based on oxides or mixed oxides, in particular mixed oxides of SiO₂ and ZrO₂, glass fibers and/or carbon fibers, and defined mixtures comprising at least two of the abovementioned inorganic fillers, and the
E) pigments comprise titanium dioxide, X-ray opaques comprising ytterbium fluoride and/or the UV/Vis stabilizers.

11. Composition according to claim 1, wherein the composition comprises 50 to 6000 parts by weight of a further thermoplastic polymer, in particular which is not a poly(dialkylphenylene) ether and not a styrene polymer or a mixture thereof, preferably the further thermoplastic polymer comprises polystyrene, polyethylene, polypropylene and/or polyamide.

12. (canceled)

13. Process for the preparation of a composition according to claim 1, wherein the composition is obtained
i) by mixing
A) 5 to 5000 parts by weight of poly(dialkylphenylene) ether, wherein alkyl having 1 to 6 C atoms,
B) 100 parts by weight of thermoplastic styrene polymer,
C) 10 to 1500 parts by weight core-shell particles,
D) 0 to 2550 parts by weight of inorganic filler, and
E) 0.001 to 300 parts by weight of pigment, x-ray opaque and/or UV/Vis stabilizer, and
obtaining a mixture comprising A), B), C), D) and E), and
heating the mixture to a temperature above the softening temperature of the A) poly(dialkylphenylene) ethers with alkyl having 1 to 6 carbon atoms, and
obtaining a thermoplastic composition comprising A), B), C) and D) and/or E), or
ii) by mixing
A) 5 to 5000 parts by weight of poly(dialkylphenylene) ether with alkyl having 1 to 6 C atoms,
B) 100 parts by weight of thermoplastic styrene polymer, and
obtaining a mixture comprising A) and B) and
heating the mixture to a temperature above the softening temperature of the A) poly(dialkylphenylene) ethers with alkyl having 1 to 6 carbon atoms, and
obtaining a homogeneous mass comprising A) and B), and
Mixing the homogeneous mass of A) and B) with
C) 10 to 1500 parts by weight core-shell particles,
D) 0 to 2550 parts by weight of inorganic filler, and
E) 0.001 to 300 parts by weight of pigment, X-ray opaque and/or UV/Vis stabilizer,
obtaining a mixture comprising the homogeneous mass, C), D) and/or E), and
heating the mixture to a temperature above the softening temperature of the A) poly(dialkylphenylene) ethers with alkyl having 1 to 6 carbon atoms, and
producing the thermoplastic composition comprising A), B), C) and D) and/or E), or
iii) by mixing
A) 5 to 5000 parts by weight of poly(dialkylphenylene) ether with alkyl having 1 to 6 C atoms,
B) 100 parts by weight of thermoplastic styrene polymer, and
C) 10 to 1500 parts by weight core-shell particles,
obtaining a mixture comprising A), B) and C) and
heating the mixture to a temperature above the softening temperature of the A) poly(dialkylphenylene) ethers with alkyl having 1 to 6 carbon atoms, and
Creating a homogeneous mass comprising A), B) and C),
Mixing the homogeneous mass of A), B) and C) with D) 0 to 2550 parts by weight of inorganic filler and/or E) 0.001 to 300 parts by weight of pigment and/or UV/Vis stabilizer,
obtaining a mixture comprising the homogeneous composition, D) and/or E) and
heating the mixture to a temperature above the softening temperature of the A) poly(dialkylphenylene) ethers with alkyl having 1 to 6 carbon atoms, and
producing the thermoplastic composition comprising A), B), C) and D) and/or E),
wherein the core-shell particles having
i) as a shell of the core-shell particles comprising polymers of acrylate, methyl acrylate and/or methyl methacrylate, and
ii) the core of the core-shell comprising polymers comprising acrylate having a TG less than −50° C., or the core of the core-shell particles having an elastic phase selected from selected from poly(n-butyl acrylates) (PBA).

14. The process according to claim 13, wherein in that A), B), C), D) and/or E), and optionally the UV/Vis stabilizer are each dried individually before mixing, and/or the mixture of A) and B), mixture of A), B), C), D), and E), the mixture of A), B), and C), the homogeneous composition comprising A), B), C), D), and/or E), the homogeneous composition comprising A) and B), the homogeneous composition comprising A), B), and C) is dried before heating.

15. A thermoplastic molded article obtainable by mixing a thermoplastic composition according to claim 1, in particular by means of processing in an extruder at elevated temperature, preferably by means of mixing at a temperature above the softening temperature of the A) poly(dialkylphenylene) ether, in particular comprising poly-(2,6-dialkyl-1,4-phenylene) ether and optionally poly-(2,6-dialkyl-1,3-phenylene) ether or mixtures thereof, with alkyl having 1 to 6 C atoms, and subsequent shaping to give a molded article and optionally cooling the molded article, preferably the thermoplastic composition is processed at above 150° C. and then molded and optionally cooled to give a thermoplastic molded article, wherein the fracture toughness is greater than 2.4 MPa·*m^{1/2} and total work of fracture is greater than 1500 J/m².

16. Thermoplastic molded body according to claim 15, wherein the thermoplastic molded body is a milling blank, cylindrical milling blank, granulate, tubular molded body, pellet, bead, polyhedron, cuboid, cylinder, sphere, three-dimensional molded body having a polyhedral basic structure and at least one curved surface, part of a prosthesis, bite splint, drilling template for implantology, mouthguard, artificial joint prosthesis, crown, telescope, veneer, dental bridge, denture tooth, implant, implant part, abutment, superstructure, orthodontic apparatus, medical instrument, veterinary prosthesis, hoof prosthesis and/or a molded body obtainable by an injection molding process.

17. Method of using a thermoplastic composition according to claim 1 as a medical product, in particular as a medical device, in particular for the manufacture of medical products, medical prostheses, instruments, apparatuses and/or parts thereof, for the manufacture of thermoplastic three-dimensional molded bodies, medical prosthetic products, dental prosthetic molded bodies, for the manufacture of dental prostheses, clasp prostheses, parts of prostheses, for the production of bite splints, of drilling templates for implantology, of mouthguards, artificial joint prostheses, crowns, telescopes, veneers, dental bridges, prosthetic teeth, implants, implant parts, abutments, superstructures, orthodontic apparatus and instruments, in the veterinary field for the production of prostheses, for the production of granules for use in laser sintering processes, in particular for the production of three-dimensional shaped bodies.

18. Method of using thermoplastic moldings according to claim 16 in an extrusion process, injection molding process, laser sintering process, Variotherm process, hot embossing process, hot pressing process.
